(19) United States
(12) Patent Application Publication
(10) Pub. No.: US 2022/0278591 A1
(43) Pub. Date: Sep. 1, 2022

(54) STATOR FOR AN ELECTRIC MACHINE

(71) Applicant: Schaeffler Technologies AG & Co. KG, Herzogenaurach (DE)

(72) Inventor: Andreas Ruppert, Bühlertal (DE)

(73) Assignee: Schaeffler Technologies AG & Co. KG, Herzogenaurach (DE)

(21) Appl. No.: 17/608,762

(22) PCT Filed: Apr. 16, 2020
(86) PCT No.: PCT/DE2020/100310

§ 371 Date: Nov. 4, 2021

(30) Foreign Application Priority Data
May 7, 2019 (DE) 10 2019 111 825.5

(51) Int. Cl. H02K 11/25; H02K 3/28; G01K 7/02

(52) U.S. Cl. CPC H02K 11/25; H02K 3/28; G01K 7/021; H02K 2203/09

(57) ABSTRACT

A stator for an electric machine, having a winding including a plurality of interconnected conductors assigned to one or more phases, wherein the ends of at least some of the conductors protrude axially or radially beyond the winding at the inner circumference and/or at the outer circumference of the winding. An interconnection ring, to which the conductors are connected, is positioned axially or radially on the winding, and at least one temperature sensor is arranged at the interconnection ring and is in thermal contact with the winding.

### CROSS-REFERENCE TO RELATED APPLICATIONS

This application is the U.S. National Phase of PCT Appln. No. PCT/DE2020/100310 filed Apr. 16, 2020, which claims priority to DE 102019111825.5 filed May 7, 2019, the entire disclosures of which are incorporated by reference herein.

### TECHNICAL FIELD

The disclosure relates to a stator for an electric machine, having a winding comprising a plurality of interconnected conductors assigned to one or more phases.

### BACKGROUND

Electric machines comprising a rotor and a stator are used in different areas of application. The use of electric machines for electric hybrid vehicles and electric vehicles, or for hub drives is to be mentioned only as an example. If such an electric machine is used as a drive machine, it is usually designed as an internal rotor, i.e., the stator surrounds the internal rotor. A moving magnetic field is generated via the stator, which causes the rotor to rotate. For this purpose, the stator has a winding consisting of a large number of conductors, wherein the conductors are assigned to one or usually more than phase.

Not only the number of phases is included in the design of the winding geometry, but also the number of wires per phase as well as the number of wires per slot within the stator toothing and the number of pole pairs. This variety of conductors and winding parameters creates a complex network of conductors that is built up using different winding technologies. Examples include hairpin or bar wave windings. Here, the conductors are formed by means of rods bent into a U-shape, which are put together to form a winding cage. The conductors are laid on a plurality of radial levels, wherein the conductors moving from level to level, so to speak. To form these meandering, circumferential conductors, they are to be connected accordingly at their ends, which is usually done by welding the conductor ends that are adjacent to one another. The conductor ends converge at one point or on one winding side in the form of what is termed a star, where they are connected to one another. In this area, the connection of the individual phases must be made to an external power supply, often also referred to as a high voltage terminal, which is used to generate the magnetic field, which is often very difficult to implement for reasons of installation space.

When the electric machine is in operation, the winding temperature must also be recorded, for which a temperature sensor is used, usually an NTC or PTC resistor element. The thermal coupling of this temperature sensor with the winding is difficult because the winding is wound or fitted very tightly, which means the temperature sensor cannot be inserted into the winding or inserted between adjacent wires. Therefore, in most cases temperature sensors with an outer protective sheath, in particular a plastic sheath such as a shrink tubing, are used, which completely surrounds the sensor head and a connecting conductor over at least part of its length, wherein the end section of the plastic sheath on the sensor head side is closed. The temperature sensor, usually a double-pole sensor, also contains a cable that is connected to the power electronics in a suitable manner. Often the cable has to bridge a long gap from the sensor to the power electronics, since a suitable connecting conductor to which the temperature sensor can generally be connected is spaced relatively far away from the power electronics.

### SUMMARY

The object of the disclosure is to specify a stator that is improved in comparison, and is as compact as possible.

To solve this problem, in a stator of the type mentioned, the disclosure provides that the ends of at least some of the conductors protrude axially or radially beyond the winding at the inner circumference and/or at the outer circumference of the winding, wherein an interconnection ring, to which the conductors are connected, is positioned axially or radially on the winding, and wherein at least one temperature sensor in thermal contact with the winding is arranged on the interconnection ring.

According to the disclosure, it is provided that the actual conductor connection and the arrangement of the temperature sensor are integrated into a common component, namely in an interconnection ring which is placed axially on the end face or radially inside or outside of the winding, and which serves for the conductor connection, but which is also used at the same time the temperature sensor is arranged, which is thermally coupled to the winding and preferably rests axially, radially or tangentially on the winding. This means that the two “interconnection” and “temperature detection” systems no longer need be installed independently of one another or one after the other, but can be installed using a common component.

The interconnection ring itself makes it possible to separate the actual conductor connection, i.e., the connecting of the individual conductors to form the corresponding phase-specific meander structures, and the connection for coupling with the power supply via a high-voltage terminal, wherein the interconnection can be provided virtually radially on the inside and the connection to the power supply can be provided radially on the outside, for example if the ends of at least two conductors assigned to a phase protrude radially or axially outward and are connected to a power connection arranged radially outside the winding. Consequently, the interconnection ring is used for the actual conductor connection, i.e., a conductor ring that is placed separately on the winding and that is placed axially or radially on the winding. This interconnection ring engages in the region of axially or radially protruding conductor ends on the inner circumference and/or on the outer circumference of the winding, for example when placed axially between the conductor ends protruding axially beyond the winding in the area of the inner and outer circumference of the winding. The conductor ends are assigned to the individual conductor sections, unless they are connected to one another on other, for example further inward, radial planes. The conductor ends are connected to the interconnection ring, usually welded to it, so that the corresponding phase-specific conductor structures are generated via the interconnection ring.

To connect the winding to the actual power connection, for example, corresponding conductor ends that are assigned to a phase are guided protruding radially or axially outward. A power connection arranged radially next to the winding head can now be connected accordingly to these conductor ends led radially or axially outward, so that the HV power connection or the individual phase-related terminals can be connected to the corresponding phase-specific conductor ends, and of course can also be welded here.

According to the disclosure, the temperature sensor is now also connected to this interconnection ring, that is to say integrated on the ring, so that a common component is obtained, which is used on the one hand for conductor connection and on the other hand for temperature detection. This means that by attaching the interconnection ring, for example axially placing the interconnection ring, the temperature sensor is also positioned at the same time and brought into thermal contact with the winding. For this purpose, the temperature sensor is also seated axially on the winding when the interconnection ring is axially placed, for example; in the case of a radial arrangement of the interconnection ring, it would sit radially.

The combined component according to the disclosure comprising an interconnection ring together with a temperature sensor enables the stator to have a very compact structure which at the same time, is simple to assemble. The almost nested, for example, axial and radial arrangement of the interconnection ring and power supply terminal, results in a very compact, space-saving structure. In addition, the assembly is also simplified, since the conductors or wires to be connected via the interconnection ring only need be cut to length and brought into the appropriate position when the winding cage is plugged together in order to be connected to the corresponding connection terminals of the interconnection ring, which are of course positioned accordingly. Both the cutting to length and the assembly can take place in an automated assembly process, as can of course also be compensated for due to the simple connection of conductor ends and interconnection ring. This is not least due to the fact that the interconnection ring and the power supply or the HV terminal are two separate assemblies that are connected in different process steps to the stator and then also to the finished electric machine.

However, at the same time as the interconnection ring is placed, the assembly and thermal coupling of the temperature sensor also take place, which means that no additional, separate assembly steps are required for the sensor assembly. Rather, if the interconnection ring is set and assembled automatically, the temperature sensor assembly can also be automated, which simplifies the entire assembly process. In addition, due to the integration of the temperature sensor in the interconnection ring, a very compact design is possible, since no separate lines and the like are required for the electrical connection of the temperature sensor, since the line connection to the power electronics can also be routed through the interconnection ring.

The interconnection ring itself expediently has a housing in which a plurality of separate line bridges are arranged, wherein the temperature sensor is arranged in or on the housing and protruding towards the winding. The integrated component thus has a housing that closes it off from the outside, which makes it possible to completely prefabricate the component and to assemble it as a compact housing component. A plurality of line bridges, which are stable metal sheets, which are geometrically shaped so that they reach the conductor ends to be connected, are grouped into the corresponding circuit ring and allow easy bridging of corresponding distances both in the circumferential and radial direction. These line bridges, like the individual conductors, are of course isolated from one another. Furthermore, the temperature sensor is arranged in or on the housing in such a way that it protrudes from or on the housing towards the winding. The housing thus offers a simple, standardized interface for positioning and mounting the temperature sensor, so that it is ensured that the temperature sensor is always positioned in a way that enables reliable thermal contact with the winding.

The housing in which the bridges and on which the temperature sensor is arranged preferably has corresponding radial apertures for the protruding connections of the individual conductor bridges emerging here, and one or more, corresponding to the number of temperature sensors to be mounted, axial apertures through which the temperature sensor, or sensors, of which a plurality can of course also be provided, protrude from the housing and extend towards the winding, or through which run the connection lines of the temperature sensors arranged on the outside of the housing. This configuration is expedient when the interconnection ring is placed axially. If the interconnection ring is placed radially, the apertures and the protruding conductor bridge sections can protrude axially, while the apertures for the temperature sensors are aligned radially so that the temperature sensors sit radially on the outer circumference of the winding. The housing is preferably a plastic housing, which enables simple manufacture.

According to an advantageous embodiment of the disclosure, it is provided that the temperature sensor is spring-loaded against the winding via an elastic element. This elastic element and the spring-loading ensure that the temperature sensor is pressed firmly against the winding, on the one hand, and is therefore brought into firm thermal contact with it. On the other hand, any tolerances between the interconnection ring or the housing and the winding surface can also be compensated for.

Of course, the temperature sensor can also be arranged in a fixed position, i.e., not flexibly on the housing via an elastic element, if it is ensured that it comes into defined thermal contact with the contact surface of the winding.

If such an elastic element is used, a plastic component, in particular a silicone or elastomer component, is preferably used; alternatively, a spring element can also be provided. For improved thermal conductivity, the elastic element can also have a metal element, in particular a copper core, which is thermally coupled to the temperature sensor so that the metal element is practically in contact with the winding and thermally connected with the temperature sensor, which is then virtually indirectly coupled to the winding. This enables the temperature to be conveyed better and more directly to the temperature sensor or what is termed the “sensor bead”.

It is particularly preferable if the temperature sensor and/or the metal element, preferably both, of course, is embedded in the plastic component, that is to say, for example, injected or poured into the silicone or elastomer component. This results in a compact temperature sensor component that provides flexibility or spring-like properties so that the embedded temperature sensor, which is designed, for example, in the form of a sensor bead and, for example, protrudes slightly away from the plastic material, can be spring-loaded accordingly. In addition, if the metal element, for example in the form of one or more suitable metal strips or the like, is also embedded, this joint embedding can bring it into thermal contact with the adjacent winding over a large area, which means that a larger, two-dimensional temperature sensor component is obtained.

The temperature sensor or the temperature sensor component can, as already described, rest axially, radially or tangentially on the winding. Ultimately, the alignment and thermal coupling of the sensor depends on how the interconnection ring is placed on or attached to the winding.

The temperature sensor itself is preferably a thermocouple, e.g., an NTC or a PTC sensor. While it is sufficient to provide only one temperature sensor on the interconnection ring, it is of course also conceivable to arrange a plurality of temperature sensors or temperature sensor components distributed along the interconnection ring.

In addition to the stator itself, the disclosure also relates to an electric machine comprising a stator of the type described above.

### BRIEF DESCRIPTION OF THE DRAWINGS

The disclosure is explained below on the basis of exemplary embodiments with reference to the drawings. The drawings are schematic representations, wherein:

FIG. 1 shows a schematic diagram in the form of a partial view of a stator according to the disclosure,

FIG. 2 shows a partial view of the interconnection ring,

FIG. 3 shows a schematic diagram of various line bridges of the interconnection ring from FIG. 2, as well as two temperature sensor components,

FIG. 4 shows an enlarged, perspective view schematic diagram of a temperature sensor component,

FIG. 5 shows a perspective view of the actual temperature sensor, and

FIG. 6 shows a partial view of the stator with the interconnection ring attached and the temperature sensor component in thermal contact.

### DETAILED DESCRIPTION

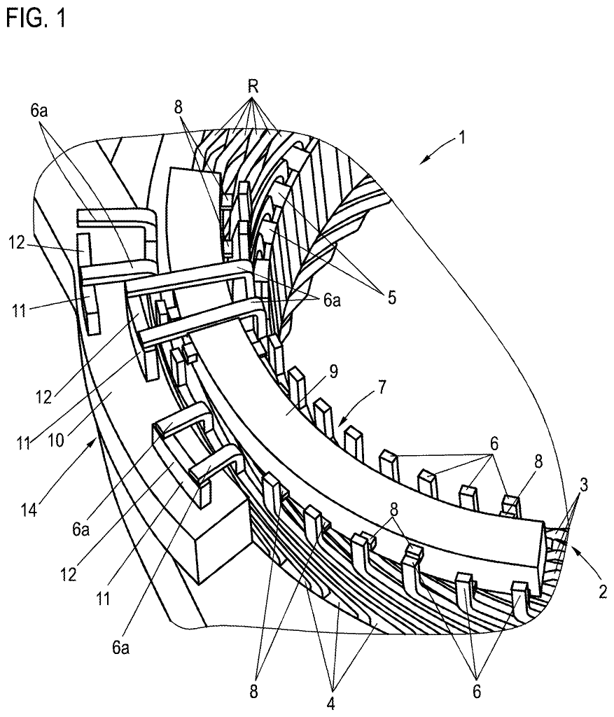

FIG. 1 shows, in the form of a partial view, a schematic illustration of a stator 1 according to the disclosure of an electric machine, having a winding 2 comprising a plurality of conductors 3, which are assigned to three separate phases in the example shown. More or fewer phases can also be provided. Each conductor 3 is designed almost like a U-shaped bracket, wherein a plurality of such U-shaped conductors, often also called hairpins, are plugged together to form the winding 2, which can also be referred to as a winding cage. The plurality of conductors 3 define different radial planes R, as shown in FIG. 1. For this purpose, the conductors 3 extend, depending on the winding diagram, from one radial plane to another radial plane, for example an adjacent radial plane, in the region in which they are connected to the conductor ends of corresponding adjacent conductors continuing the phase conductor.

The conductors are guided or bent and laid in such a way that corresponding recesses 4 result, which extend radially so that corresponding stator teeth 5 engage in these recesses 4 or the corresponding conductors are wound between the corresponding grooves of the stator teeth 5. The basic structure of such a stator or a winding 2 wound from the separate brackets described is basically known.

In the stator 1 according to the disclosure, the ends 6 of the conductors 3, insofar as the ends 6 terminate respectively at the inner circumference and the outer circumference of the annular winding 2, are axially protruding, i.e., they protrude axially from the winding 2. These ends are associated with individual conductors, which in turn are assigned to different phases, which is why the conductor ends must be connected according to the routing diagram of the conductor 3. For this purpose, an interconnection ring 7 is used, which is placed axially on the end face of the winding 2 and is arranged between the conductor ends 6 or engages therebetween. The interconnection ring 7 comprises, as will be discussed below, a plurality of corresponding line bridges and connection sections 8, which protrude to the side from the housing 9 of the interconnection ring 7 and are positioned precisely next to the corresponding conductor end 6 after the interconnection ring 7 has been inserted between the conductor ends 6 with which they are to be connected. The connection is made, for example, by simple welding so that all conductors 3 are correctly and phase-specifically interconnected when they are connected. Other connection methods are also conceivable.

Furthermore, a power supply 14 is provided, which is arranged radially next to the winding 2 in the region of its axial end. This power supply 14, also referred to as a HV terminal, comprises a housing 10, in which corresponding busbars 11 are arranged, which protrude with their connection terminals 12 from the housing.

In the present case, as described, a 3-phase stator is shown, which is why three such connection terminals 12 are also provided in the example shown.

Each connection terminal 12 is to be connected to one phase of the winding 2.

This is implemented in a simple manner in that two conductor ends 6a per phase are guided or bent radially outwards, as FIG. 1 clearly shows. The two conductor ends 6a arranged on the outer circumference of the winding 2 are relatively short and can be bent directly outwards, while the two conductor ends 6a arranged on the inner circumference are longer and overlap the interconnection ring 7. They run above the connection terminals 12 so that a simple welded connection for making contact is possible there as well. The connection to the power supply 14 does not take place until the conductors 3 are interconnected via the interconnection ring 7.

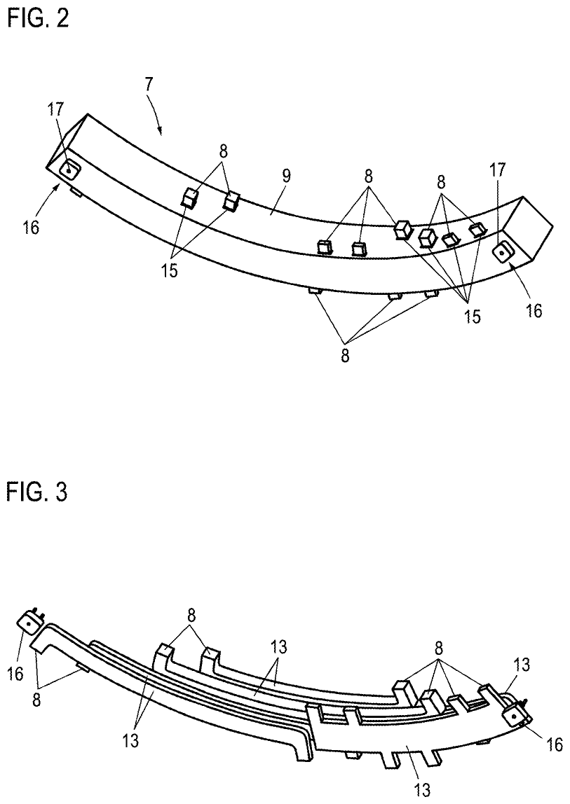

FIG. 2 shows a partial view of the interconnection ring 7 according to FIG. 1. The housing 9 is shown, which is accordingly in several parts and also enables radial encapsulation. It is preferably made of plastic. It can be seen that the corresponding connection sections 8, which are assigned to different phases, protrude from the housing 9 through corresponding openings 15. As already described, the individual connection sections are assigned to different phases, i.e., connecting different conductor ends. In the example shown, two temperature sensor components 16, which are used to detect the winding temperature, are also arranged or integrated on the interconnection ring 7. The temperature sensor components 16 are arranged in or on the housing and received in corresponding openings 15 of the housing 9, through which they protrude axially in the example shown, or through which the connecting lines are guided when the temperature sensor components 16 are arranged on the outside. In the assembly position, as will be discussed below, they come to rest axially on the winding end surface so that they are in thermal contact with the winding 2. Due to the fact that the temperature sensor components 16 (instead of the two temperature sensor components shown, only one temperature sensor component 16 or more than two temperature sensor components 16 can be provided) are arranged on the housing 9 together with the line bridges 13, this results in a combined component which is used for the conductor connection on the one hand, and for the temperature detection on the other. By attaching only this single, compact interconnection ring 7, all line connections can consequently be closed, while at the same time the thermal contacting and thus the assembly of the temperature detection device is also possible.

FIG. 3 shows various separate line bridges 13 in the form of a schematic diagram, wherein in the example shown, six line bridges 13 are depicted which are arranged axially and radially offset from one another. On the respective inner or outer circumference of the line bridges 13, the corresponding connection sections 8 are formed, which in their entirety form a corresponding star distributor. Corresponding conductor ends arranged offset in the circumferential direction can accordingly be connected accordingly on the inner and outer circumference via the line bridges 13 extending in the circumferential direction so that the corresponding meander structure of the individual phase conductors is formed in this way or provided with the like.

Furthermore, the two temperature sensor components 16 are shown, which are arranged at suitable positions where there is corresponding free space for integration between the line bridges 13. The arrangement of the line bridges 13 shown corresponds to that which is received in the housing 9 according to FIG. 2.

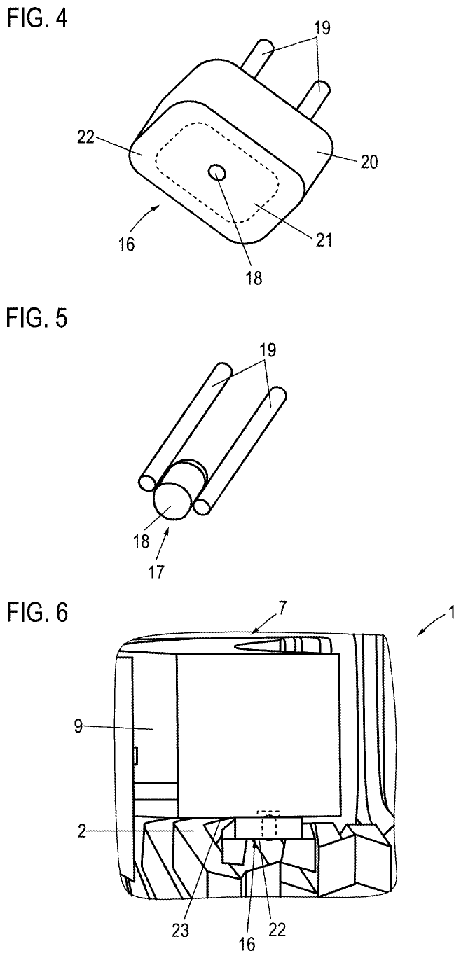

FIG. 4 shows a temperature sensor component 16 in the form of a perspective schematic diagram. This includes a temperature sensor 17 shown in FIG. 5 with the actual NTC or PTC sensor 18, often also known as a sensor bead, and two signal lines 19 via which the temperature sensor component 16 is connected to the power electronics located externally to the interconnection ring 7. The corresponding signal lines 19 are led through the interconnection ring 7 or the housing 9 to the corresponding connections of the power electronics.

To form the temperature sensor component 16, the temperature sensor 17 is embedded in an elastic element 20, preferably an elastic plastic component made of silicone or an elastomer, as shown in FIG. 4. A metal element 21 or a metal core, which is in thermal contact with the sensor element 17 and via which metal element 21 the contact area with the actual winding 2 can be increased even further, can also be embedded in this elastic element 20. The metal element would be exposed on the flat underside 22, so that it would immediately come into thermal contact with the winding 2 when the interconnection ring 7 is mounted. However, such a metal element 21 is optional.

The elastic element 20 represents a pretensioning means, by means of which the temperature sensor 17 is spring-loaded against the winding surface, that is to say is pressed against it, wherein the elastic element 20 is able to be counter-mounted on the housing 9. This ensures that even if the distance between the underside of the housing and the upper side of the winding varies slightly, the temperature sensor 17 is always in thermal contact with the winding surface. The elastic element 20 therefore represents a compensation element.

Finally, FIG. 6 shows a partial view of the stator 1 according to the disclosure and the winding 2 as well as the interconnection ring 7. It can be seen that the temperature sensor component 16 is arranged on the underside 23 of the housing 9 or is supported there.

The signal lines 19 are led through the opening 15 into the interior of the housing. The temperature sensor component 16 is pressed with its underside 22 against the winding 2, so that the temperature sensor 17 is in thermal contact with the winding 2 and can therefore detect its temperature.

### LIST OF REFERENCE NUMBERS

1 Stator

2 Winding

3 Conductor

4 Recess

5 Stator tooth

6 Conductor end

7 Interconnection ring

8 Connection element

9 Housing

10 Housing

11 Conductor rail

12 Connection terminal

13 Line bridge

14 Power supply

15 Opening

16 Temperature sensor component

17 Temperature sensor

18 NTC or PTC sensor

19 Signal line

20 Element

21 Metal element

22 Underside

23 Underside

1. A stator for an electric machine, comprising: a winding, including a plurality of interconnected conductors assigned to one or more phases, wherein ends of at least one of the conductors protrude axially or radially beyond the winding at an inner circumference or at an outer circumference of the winding, wherein an interconnection ring, to which the conductors are connected, is positioned axially or radially on the winding, and wherein at least one temperature sensor is arranged at the interconnection ring and is in thermal contact with the winding.

2. The stator according to claim 1, wherein the interconnection ring has a housing in which a plurality of line bridges are arranged, wherein the temperature sensor is arranged in or on the housing protruding towards the winding.

3. The stator according to claim 1, wherein the temperature sensor is spring-loaded against the winding via an elastic element.

4. The stator according to claim 3, wherein the elastic element is a plastic component or a spring element.

5. The stator according to claim 3, wherein the elastic element has a metal element which is thermally coupled to the temperature sensor.

6. The stator according to claim 5, wherein the temperature sensor or the metal element is embedded in the elastic element.

7. The stator according to claim 1, wherein the temperature sensor rests axially, radially or tangentially on the winding.

8. The stator according to claim 1, wherein the temperature sensor is a thermocouple.

9. The stator according to claim 1, wherein a plurality of temperature sensors are arranged distributed on the interconnection ring.

10. An electric machine, comprising a stator according to claim 1.

11. The stator according to claim 4, wherein the plastic element is a silicone component or an elastomer component.

12. The stator according to claim 5, wherein the metal element is a copper core.
